(19) United States
(12) Patent Application Publication
(10) Pub. No.: US 2020/0175620 A1
(43) Pub. Date: Jun. 4, 2020

(54) PERSONAL SOCIAL TRAVEL MAP

(71) Applicant: FOOTPRINT INDUSTRIES, INC., San Diego, CA (US)

(72) Inventors: Christophe Heinz SCHILLING, San Diego, CA (US); Byron Timothy BIGGINS, Lake Oswego, OR (US)

(21) Appl. No.: 16/088,003

(22) PCT Filed: Mar. 23, 2017
(86) PCT No.: PCT/US2017/165666

§ 371 Date: Sep. 24, 2018

(51) Int. Cl. G06Q 50/14; G06Q 30/02; G06F 16/29; G06F 16/23; G06F 16/2457

(52) U.S. Cl. CPC G06Q 50/14; G06Q 30/0269; G06F 16/24575; G06F 16/2379; G06F 16/29

(57) ABSTRACT

Systems and methods for personal social travel mapping are provided. A server maintains a travel profile for a plurality of users and translates a user's travel profile information into a visual representation having geographic boundaries (footprint). The footprints of two or more users can be compared and analyzed to identify common travel patterns, suggest user connections, identify a set of users to send queries to, identify targeted advertising to send to a user and filter content items. A user's social connections can also be used to filter comments on content items. The system includes a server device and may also include a mobile device with location tracking capability to automatically notify the server device of a user's travel and a messaging capability to allow the user to communicate with other users.

### BACKGROUND

### Field of the Invention

The present application generally relates to travel and more specifically relates to generating and maintaining a personal travel map for users.

### Related Art

Conventional travel services primarily help users plan travel, allowing them to research destinations and modes of transportation. Users themselves carry a wealth of travel experiences they may maintain in a travel journal, which may reside on paper, in a computer, or in their head. These experiences can be helpful for them to plan their own travel or to help others plan travel. However conventional travel services suffer because they are generally isolated from a user's social media. Therefore, what is needed is a system and method that overcomes these significant problems found in the conventional systems as described above.

### SUMMARY

To address the problems found in conventional travel services, described herein are systems and methods for personal social travel mapping. In one embodiment, a server creates and updates a travel profile for a plurality of users. The travel profile includes at least a set of completed travel locations, a set of scheduled travel locations and a set of desired travel locations for each user. The system also analyzes the travel profile for each user and generates a data structure representing a map of the geographic boundaries of the set of completed travel locations, the set of scheduled travel locations and the set of desired travel locations for each user. These data structures (also referred to herein as a “footprint”) can be translated into a visual representation having geographic boundaries and presented in the form of a map on a display being viewed by a user. Additionally, the footprints of two or more users can be compared and analyzed to identify common travel patterns, suggest social connections between users, identify a set of users to send queries to, identify targeted advertising to send to a user and filter content items. These users can be part of a private social network, rather than being open to the public, providing privileged access to each users footprint and travel experiences.

In an alternative embodiment, the server device is augmented with a mobile device having a location tracking capability. The mobile device executes an application that automatically notifies the server device of a user's travel. The application also provides messaging capabilities that allows a user of the mobile device to communicate with other users via the server device and allows the server device to initiate communications with any user within their private network or potentially with other users that could be invited to join their network.

In one embodiment, the server device uses a user's social connections to other users to filter comments on content items. Specifically, the server device analyzes the comments associated with a content item being viewed by a first user and excludes those comments that were not authored by a second user having an existing social connection with the first user.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for a personalized social travel map according to an embodiment of the invention;

FIG. 2 is a block diagram illustrating an example server according to an embodiment of the invention;

FIG. 3 is a block diagram illustrating an example mobile application according to an embodiment of the invention;

FIG. 4 is a flow diagram illustrating an example process for visually comparing travel footprints according to an embodiment of the invention;

FIG. 5 is a flow diagram illustrating an example process for sending targeted advertising to a user according to an embodiment of the invention;

FIG. 6 is a flow diagram illustrating an example process for geographic term searching according to an embodiment of the invention;

FIG. 7 is a flow diagram illustrating an example process for filtering posts related to a content item according to an embodiment of the invention;

FIG. 8 is a flow diagram illustrating an example process for filtering content items according to an embodiment of the invention;

FIG. 9 is a flow diagram illustrating an example process for suggesting travel destinations according to an embodiment of the invention;

FIG. 10 is a flow diagram illustrating an example process for suggesting friend connections according to an embodiment of the invention;

FIG. 11 is a flow diagram illustrating an example process for automatically updating a user footprint according to an embodiment of the invention; and

FIG. 12 is a block diagram illustrating an example wired or wireless processor enabled device that may be used in connection with various embodiments described herein.

### DETAILED DESCRIPTION

Certain embodiments disclosed herein provide for personal social travel mapping. For example, one method disclosed herein allows for a server device to analyze the travel footprint for two or more users and identify common travel patterns, suggest social connections between users, identify a set of users to send queries to, identify targeted advertising to send to a user. The server device can also filter content items being delivered to a user based on the user's footprint. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

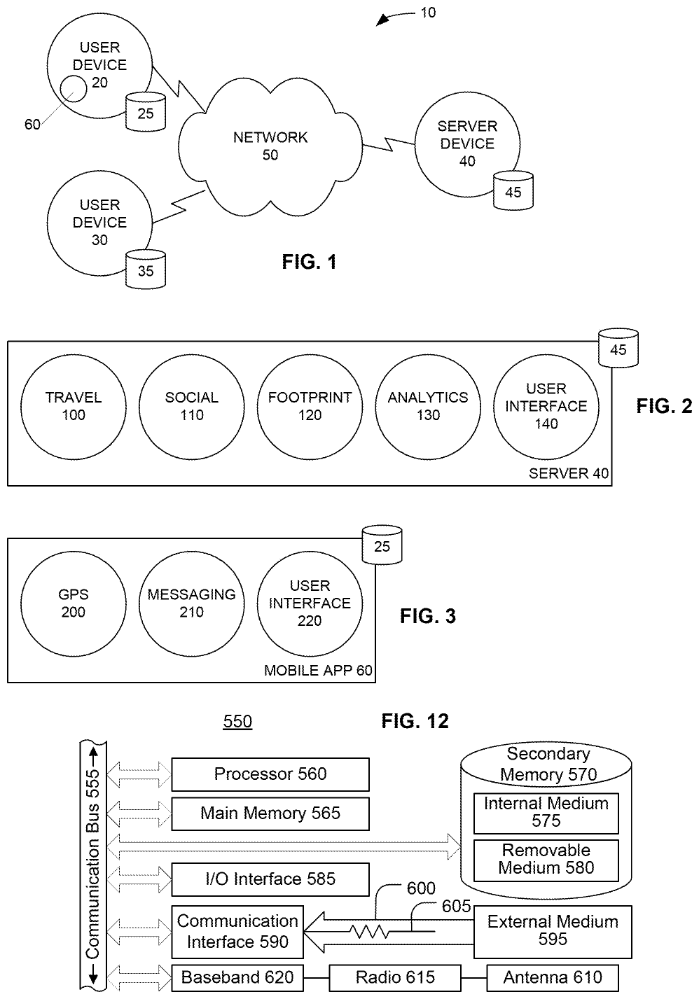

FIG. 1 is a network diagram illustrating an example system 10 for personalized social travel mapping according to an embodiment of the invention. In the illustrated embodiment, the system 10 comprises a travel server device 40 that is communicatively coupled with a plurality of user devices 20 and 30 via a network 50. A user device such as user device 20, may include a locally executed travel application 60 that facilitates communication between the user device 20 and the server device 40. Alternatively, the user device, such as user device 30 may communicate with the travel server device 40 using a standard web browser as the interface.

The user device 20 or 30 may be any sort of processor enabled device such as described later with respect to FIG. 12. In one embodiment, the user device 20 is a mobile device that a user carries. Advantageously, the mobile device has a location tracking capability and the user device 20 has a locally executed application that obtains location information for the user device 20 and provides that information to the travel server device 40 so that the travel server device 40 can update the travel profile information and footprint of the user. Each user device 20 and 30 has a local data storage area 25 and 35, respectively and the travel server device 40 also has a local data storage area 45. The various data storage areas may also include remote data storage accessed via the network 50.

FIG. 2 is a block diagram illustrating an example travel server 40 according to an embodiment of the invention. In the illustrated embodiment, the travel server 40 comprises a travel module 100, a social module 110, a footprint module 120, an analytics module 130 and a user interface module 140.

The travel module 100 is configured to receive travel information associated with a user and update a travel profile for the user. The travel module may receive such information through a user interface presented to a user on the monitor of a user device being viewed by the user. For example, the travel module may receive information that is entered into data entry fields that are part of a user interface that is displayed in a web browser that is presented to a user on the monitor of a user device being viewed by the user. The travel profile may include a variety of information such as a location where the user was born, locations where the user previously resided and currently resides, a set of completed travel locations that the user has visited in the past, a set of scheduled travel locations that the user is scheduled to visit in the future, and a set of desired travel locations that the user would like to visit in the future. The travel module 100 also allows the user to maintain a journal with information corresponding to the user's travel locations.

In one embodiment, the travel module 100 receives travel information as input from a travel application executing on a mobile device of a user. Travel information received from a travel application executing on a mobile device of a user may include location information, for example, information originating from a location tracking capability of the mobile device such as a global positioning system (“GPS”) radio and corresponding software. The travel module 100 is configured to incorporate the travel information into the user's travel profile to accurately and automatically update the user's footprint in a very timely fashion.

The social module 110 is configured to allow users to establish connections to other users of the system or invite other users to join the system and their social network in order to gain privileged shared access to each other's footprint and travel experiences. It is also configured to interface with one or more third party social network applications and leverage existing third party user connections to establish user connections. For example, the social module 110 may access a user's Facebook profile and identify Facebook friends and then suggest that the user invite the Facebook friend to connect as users within the travel server. Other third party social network applications may also be accessed, for example Instagram, Twitter and LinkediN. In one embodiment, a user's connections are separated into personal and business connections.

In one embodiment, the social module 110 is configured to analyze a travel query submitted by a user and search the footprints of a user's connections within the travel server (i.e., a user's friends), and identify one or more user connections that include locations responsive to the analyzed travel query.

In one embodiment, the social module 110 is configured to analyze comments associated with a content item being viewed by a user and compare the author of each comment to the user's connections. The social module 110 advantageously excludes or collapses out of view those comments written by authors who are not also one of the user's connections. For example, the social module 110 analyzes the user authored comments associated with a digital media item (e.g., a travel story) and excludes all comments authored by users who are not currently in the list of user connections (i.e., friends) of the user.

In one embodiment, the social module 110 interfaces with an application executing on a user's mobile device to allow the user to send messages to one or more users. For example, the application executing on the user's mobile device receives message information as an input from the user and provides the message information to the social module 110. The social module 110 parses a message content and a list of recipients (i.e., one or more recipients) from the message information and sends the message content to the users in the list of recipients. The social module 110 is also configured to provide response messages from the one or more message recipients to the user.

In one embodiment, the application executing on a user's mobile device provides the social module 110 with the current location of the mobile device and the social module 110 identifies a list of one or more of the user's connections that have a footprint that is associated with the current location. A user's footprint may be associated with a particular location by way of the having the location in the set of completed travel locations that the user has visited in the past, or the set of scheduled travel locations that the user is scheduled to visit in the future, or the set of desired travel locations that the user would like to visit in the future, or the location where the user currently lives. The social module 110 advantageously can prompt the user to request that the user send a message to one or more of the user's connections that have a footprint that is associated with the current location.

The social module 110 is also configured to analyze the content of one or more digital media items being provided to a device having a display being viewed by the user. The social module 110 advantageously compares the content of the digital media item to the user's footprint and identifies those digital media items that include content that is related to the user's footprint. The social module 110 excludes those digital media items that are not related to the user's footprint from being presented to the user on the display of the device. For example, the social module 110 analyzes a news feed or twitter feed or Instagram feed or other source of digital media items and excludes all items that are not related to the user's footprint.

The footprint module 120 is configured to analyze travel information in a user's travel profile and generate a data structure representing a map of the geographic boundaries of the set of completed travel locations that the user has visited in the past, the set of scheduled travel locations that the user is scheduled to visit in the future, the set of desired travel locations that the user would like to visit in the future, and the location where the user currently lives, has lived in the past, or where the user was born. The footprint module 120 is also configured to generate a visual representation based on the data structure, where the visual representation has geographic or geopolitical boundaries and is presented in the form of a map on a display being viewed by a user. The geographic or geopolitical boundaries can be at the zip code, city, state, province, country, or continent level and can also be a uniquely defined region that is very large (e.g., North America, Latin America) or very small (e.g., neighborhood or school district).

The analytics module 130 is configured to analyze a user's footprint data and identify targeted advertising for delivery to a display being viewed by the user based on the analysis that determines a correspondence between an advertisement and the set of completed travel locations that the user has visited in the past, the set of scheduled travel locations that the user is scheduled to visit in the future, the set of desired travel locations that the user would like to visit in the future, and the location where the user currently lives. In one embodiment, the analytics module 130 obtains a current location for the user (e.g., by receiving location tracking information from an application executed on a mobile device being carried by the user) and compares the current location to advertising information and to the users footprint to identify a correspondence between the current location as well as the users travel habits and one or more advertisements. The analytics module 130 is also configured to cause the one or more corresponding advertisements to be presented on the display of a user device.

The analytics module 130 is also configured to receive a search criteria from a user and identify a geographic location corresponding to the search criteria and then search a plurality of user footprints to generate a list users that correspond to the geographic location corresponding to the search criteria. Advantageously, the plurality of user footprints searched can be limited to only friends of the user or the plurality of footprints searched can be further limited or limited in some other fashion or not limited at all.

The analytics module 130 is also configured to analyze the footprints of a plurality of users to identify common travel patterns, for example a visit to a first travel location followed by a visit to a second travel location and a mode of transportation between the first and second travel locations. These common travel patterns allow the analytics module 130 to suggest travel location destinations when a user is planning future travel. For example, if a user selects the first travel location as a destination for an upcoming trip, the analytics module 130 can present on a display being viewed by the user a suggestion to add the second travel location as an additional destination and further suggest the mode of transportation for traveling between the first and second travel locations. Furthermore, the analytics module 130 is configured to analyze travel information and determine a travel score rating for each user. The travel score rating can be used to rank users against each other or as a selection criteria for the particular targeted advertising received by the user. Additionally, the analytics module 130 is configured to analyze travel information and determine a travel score rating for a segment of travel from a first travel location to a second location, perhaps with one or more travel locations between the first and second travel locations. One particular advantage of scoring the trek is that the analytics module can suggest alternative travel location destinations when a user is planning future travel based on the difficulty of the trek (i.e., the trek score). For example, if a user selects the first travel location as a destination for an upcoming trip followed by a second location with one or more destinations in between, the analytics module 130 can present on a display being viewed by the user a suggestion to alter the one or more destinations in between based on the difference in the trek score between the user's original sequence of destinations and the analytics module 130 suggested sequence of destinations that has a lower trek score and is therefore more easily achieved. The analytics module 130 may even suggest one or more modes of transportation for traveling between the destinations between the first and second travel locations.

The user interface module 140 is configured to present information on a display being viewed by a user and receive input from a user and provide the user input for processing.

FIG. 3 is a block diagram illustrating an example mobile application 60 according to an embodiment of the invention. In the illustrated embodiment, the mobile application 60 comprises a global positioning system module 200, a messaging module 210 and a user interface module 220. In one embodiment, the mobile application 60 is stored in a data storage area 25 that can be accessed by the processor of the mobile device and the mobile application 60 can also be executed by the processor of the mobile device.

The GPS module 200 is configured to obtain location tracking information from a location tracking service of the mobile device. For example, in one embodiment the mobile device has a GPS radio and corresponding software that obtains location information for the mobile device. The GPS module 200 is configured to access the location information and provide the location information to the travel server device. The location information may be in the form of raw GPS data or it may be translated into a more commonly understood format by the GPS module 200 or before the GPS module 200 accesses the location information.

The messaging module 210 is configured to allow the user of the mobile device to send and receive messages with other users of the travel server. In one embodiment, the messaging module 210 allows the user to compose and send a message from a mobile device to one or more users of the travel server and the messaging module 210 also allows the user to receive and read a message from the travel server or from one or more users of the travel server. For example, when a user arrives at a new travel location that is new to the user's footprint, the travel server may cause the messaging module 210 to prompt the user to send a message to all of the user's friends that have an association with the new travel location in their respective footprints.

The user interface module 220 is configured to present information on a display of the mobile device and receive input from a user of the mobile device and provide the user input to the mobile application or the travel server for processing.

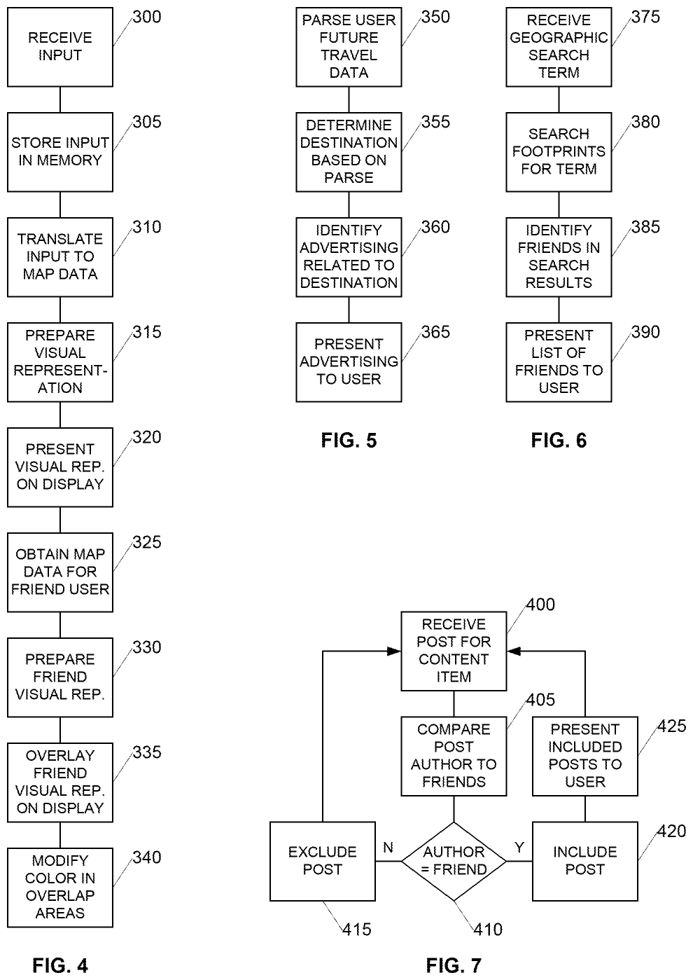

FIG. 4 is a flow diagram illustrating an example process for visually comparing travel footprints according to an embodiment of the invention. The illustrated process can be implemented by a system such as previously described with respect to FIGS. 1-3 and 12. Initially in step 300, the travel server receives input comprising travel information. For example, the input can be received from a mobile user device or a desktop user device or some other type of device being operated by a first user. The input comprising travel information may include a variety of information such as a current geographic location for the first user, a current venue for the first user (e.g., hotel or restaurant), a comment or other form of text narrative, a digital image or video or audio or some combination of digital image/video/audio.

Upon receiving the input, the travel server stores the input in memory in association with the first user as shown in step 305. Next, in step 310 the input is translated into map data. In one embodiment, this translation includes creating or updating a data structure that represents a map of the geographic boundaries of the set of completed travel locations, the set of scheduled travel locations and the set of desired travel locations for the first user. Additional information related to the geographic boundaries such as the previously described digital media/digital content items (e.g., text, image, audio, video, or any combination of these).

At any time after the data structure has been created, a visual representation of the data structure can be prepared, as shown in step 315. The visual representation can then be presented in the form of a map on a display being viewed by a user, as shown in step 320. Next, the travel server obtains the footprint (i.e., data structure) for a second user that has an existing friend connection with the first user. A visual representation of the second user's data structure is prepared in step 330 and then the second user's visual representation is presented on the same display as an overlay to the first user's visual representation. Advantageously, where the first and second user's visual representations overlap to indicate that both users have the same location/region in their respective footprints, the visual presentation of that location/region on the display can be modified to indicate the overlap. For example, when the first user's visual representation is presented on the display, the country of France may be shown in a first color to indicate that the first user has visited France. Subsequently, when the second user's visual representation is also presented on the display, the country of France may be shown in a second color to indicate that both the first user and the second user have visited France. Alternatively, or in addition, such comparative information may also be presented in different formats such as a table or list format alone or in combination with a more geographical map presentation.

FIG. 5 is a flow diagram illustrating an example process for sending targeted advertising to a user according to an embodiment of the invention. The illustrated process can be implemented by a system such as previously described with respect to FIGS. 1-3 and 12. Initially in step 350 the travel server parses travel data for a first user. Specifically, the travel server parses future travel data such as scheduled travel locations and desired travel locations that are part of the first user's footprint. Based on the parse, in step 355 the travel server determines one or more travel location destinations for the first user and then compares the determined destinations to advertising information in step 360 to identify advertising that is related to one or more of the determined destinations or to a pattern of travel that represents an intended target for the advertising. The identified advertising is subsequently presented to the first user on the display of a device being viewed by the first user, as shown in step 365. In one embodiment, after the travel server analyzes a particular user's travel data, targeted advertising for that particular user may be queued up for later presentation on a display being viewed by the user, for example the next time the user is accessing the travel server through a web browser on a desktop device or the next time the user is accessing the mobile application.

FIG. 6 is a flow diagram illustrating an example process for geographic term searching according to an embodiment of the invention. The illustrated process can be implemented by a system such as previously described with respect to FIGS. 1-3 and 12. Initially, in step 375, the travel server receives a geographic search term. The search term may be received from any type of user device such as a desktop device or a mobile device. The geographic search term may include the name of a location (e.g., city, state, country, region, etc.) or the name of a venue or the like. After receiving the geographic search term, in step 380 the travel server searches the footprints of a plurality of users. In one embodiment, the travel server may search the footprints of all users or some subset of users. For example, if the search term is received from a first user, the travel server may search the footprints of only those users that have an existing friend connection with the first user. Next, in step 385 the travel server identifies other users (e.g., friends of the user or any other users) providing the geographic search term that are included in the search results. In an embodiment where the travel server limits the search of footprints to only those users with an existing friend connection to the user who submitted the search term, step 385 can be eliminated. Finally, in step 390 the travel server presents the search result on a display being viewed by the user who submitted the geographic search term. Advantageously, the search result is a list of the user's friends who have an association with the geographic search term in their respective footprints.

FIG. 7 is a flow diagram illustrating an example process for filtering posts related to a content item according to an embodiment of the invention. The illustrated process can be implemented by a system such as previously described with respect to FIGS. 1-3 and 12. Initially, in step 400 the travel server receives one or more posts related to a content item being viewed by a first user. For example, a post could be a comment authored by any person who may or may not have a user account with the travel server. Such a post could include comments, a review, or a rating of a destination, a hotel, a restaurant, a site, a method of travel in between destinations, etc. Next, in step 405 the travel server compares the post author to the list of current friends of the first user that is viewing the content item. In step 410, the travel server determines if the author of the post is a current friend of the first user and if the author is not a current friend of the first user, the post is removed or collapse from the visual display of the content item that the first user is viewing. However, if the author is a current friend of the first user, the post is included in step 420 and in step 425 the post is presented on a display of the device on which the first user is viewing the content item. The process may continue such that the travel server is able to review and include or exclude a plurality of posts that are related to a content item being viewed by the first user.

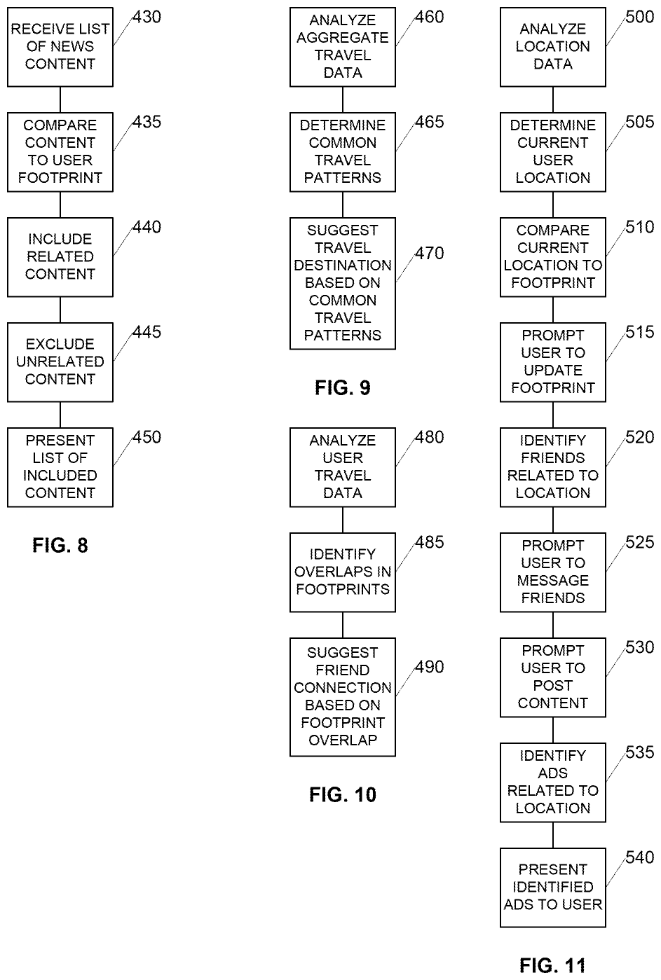

FIG. 8 is a flow diagram illustrating an example process for filtering content items according to an embodiment of the invention. The illustrated process can be implemented by a system such as previously described with respect to FIGS. 1-3 and 12. Initially, in step 430 the travel server receives one or more content items that are to be presented on a display of a device being viewed by the first user. Next, in step 435 the travel server compares content from the one or more content items to the footprint of the first user. When a content item contains content that is related to the footprint of the first user, that content item is included in step 440 such that it can be presented on a display of a device being viewed by the first user. When a content item does not contain content that is related to the footprint of the first user, that content item is excluded in step 445 such that it will not be presented on a display of a device being viewed by the first user. Finally, in step 450, a list of the included content items is presented on a display of a device being viewed by the first user such that the first user can select and view one or more of the included content items.

In one embodiment, the first user's footprint includes a plurality of travel locations and accordingly, the included content items are each related to at least one of the travel locations saved in the first user's footprint. Other information (e.g., venue locations, modes of transportation, journal entries, etc.) can also be included in the user's footprint to broaden the scope of content items that are identified as included content items.

FIG. 9 is a flow diagram illustrating an example process for suggesting travel destinations according to an embodiment of the invention. The illustrated process can be implemented by a system such as previously described with respect to FIGS. 1-3 and 12. Initially, in step 460 the travel server analyzes aggregate travel information from a plurality of users. In one embodiment, the travel server analyzes the footprints of a plurality of users. Next in step 465 the travel server determines one or more common travel patterns. For example a first common travel pattern might be to travel from Madrid to Barcelona by airplane. A second common travel pattern might be to travel from Madrid to Barcelona by train. In one embodiment, a common travel pattern comprises at least a first travel location and a second travel location and a mode of transportation between the first and second travel locations. The mode of transportation may also include a particular carrier and/or a particular time. The one or more common travel patterns can be non-specific (e.g., Madrid to Barcelona by train) or they can be very specific (e.g., Madrid Atocha Railway Station, 6:10 am departure to Barcelona Sants Train Station, 8:40 am arrival). In an alternative embodiment, a common travel pattern may include only a first travel location and a second travel location, where the first and second travel locations have an order (e.g., Madrid to Barcelona) or do not have an order (e.g., Madrid to Barcelona or Barcelona to Madrid). Once a common travel pattern has been determine, in step 470 the travel server advantageously may suggest the common travel pattern to a user when the user is planning future travel. For example, if a second user is planning future travel and includes Madrid as a travel location destination, the travel server may present on a display of a device being viewed by the second user a suggestion to add Barcelona as a travel location destination following Madrid and the travel server may also suggest traveling between Madrid and Barcelona by train and the travel sever may even further suggest traveling on the 6:10 am train from Madrid Atocha Railway Station to arrive in Barcelona at the Sants Train Station at 8:40 am.

FIG. 10 is a flow diagram illustrating an example process for suggesting friend connections according to an embodiment of the invention. The illustrated process can be implemented by a system such as previously described with respect to FIGS. 1-3 and 12. Initially, in step 480 the travel server analyzes travel data for two or more users. The travel server may accomplish this by analyzing the footprints of two or more users. Next, in step 485 the travel server identifies overlaps in the footprints of a first user and a second user that do not currently have an existing user connection (i.e., the first and second users are not currently friends). In one embodiment, the travel sever identifies an overlap when the two users have the same travel location or venue included in any portion of their footprints (e.g., visited, scheduled, desired, or currently living). The travel server may also identify an overlap when the two users have similar information in other portions of their footprints (e.g., pictures, videos, journal entries and the like). Upon identifying an overlap between the first and second users, in step 490 the travel server may advantageously suggest to one or both of the users that they may want to establish a friend user connection.

FIG. 11 is a flow diagram illustrating an example process for automatically updating a user footprint according to an embodiment of the invention. The illustrated process can be implemented by a system such as previously described with respect to FIGS. 1-3 and 12. Initially, in step 500 the travel server analyzes current location data related to a first user. In one embodiment, current location data can be GPS data that is received by the travel server from a mobile device that is being carried by the first user. Alternatively, the location data may be translated from GPS signals or triangulation signals received by the mobile device. Alternatively, the location data may be directly provided by the first user (e.g, “I am currently in Madrid, Spain”). Next, in step 505 the travel server determines a current location for the first user based on the location data, or establishes the current location of the first user as the location received from the first user. Once the current location for the first user is established, in step 510 the current location is compared to the footprint of the first user. If the current location does not appear in the footprint of the first user as determined by the comparison, in step 515 the travel server prompts the first user to update her footprint. In one embodiment, the travel server causes a message to be displayed on a display of a device being viewed by the first user. Advantageously, a positive response to the message from the first user is received by the travel server and translated into an instruction for the travel server to update the first user's footprint. In one embodiment, the server may automatically update the user's footprint with the current location, for example when the user has pre-approved such automatic updates by selecting an option in a user profile.

Next, in step 420 the travel sever identifies current friends of the first user and analyzes the footprints of those friends to identify a subset of the first user's friends that have a connection to the first user's current location in their respective footprints. Then in step 425 the travel server advantageously prompts the first user to send a message to the one or more friends in the subset of friends that have a connection to the first user's current location. Additionally, in step 530 the travel server may prompt the user to post content (e.g., text, images, audio, video, etc.) related to the first user's current location. Additionally, in step 535 the travel server identifies any advertising messages related to the first user's current location and causes those advertisements to be presented on a display of a device being viewed by the first user as shown in step 540. Alternatively, the travel server may place the related advertisements in a queue for later delivery to a display of a device being viewed by the first user.

FIG. 12 is a block diagram illustrating an example wired or wireless system 550 that may be used in connection with various embodiments described herein. For example the system 550 may be used as or in conjunction with a server device or a user device as previously described with respect to FIGS. 1 and 2. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system comprising:
a non-transitory computer readable medium configured to store information and executable programmed modules;
a processor communicatively coupled with the non-transitory computer readable medium and configured to store information in and read information from non-transitory computer readable medium, the processor also configured to execute programmed modules stored in the non-transitory computer readable medium;
a travel module stored in the non-transitory computer readable medium and configured to be executed by the processor, the travel module configured to receive travel information associated with a first user and create and update a travel profile for said first user comprising a set of completed travel locations, a set of scheduled travel locations and a set of desired travel locations; and
a footprint module stored in the non-transitory computer readable medium and configured to be executed by the processor, the footprint module configured to analyze the travel profile for said first user and generate a data structure representing a map of the geographic boundaries of the set of completed travel locations, the set of scheduled travel locations and the set of desired travel locations for said first user.

2. The system of claim 1, further comprising a social module stored in the non-transitory computer readable medium and configured to be executed by the processor, the social module configured to identify an existing connection between said first user and one or more second users, said existing connection maintained by a third party social service,
wherein, in response to a query by said first user regarding a location in said first user's set of scheduled travel locations or said first user's set of desired travel locations, the social module is further configured to identify at least one of the second users having the location in the second user's set of completed travel locations and provide the query from said first user to the identified second user.

3. The system of claim 2, further comprising an analytics module stored in the non-transitory computer readable medium and configured to be executed by the processor, the analytics module configured to analyze travel profiles for a plurality of users and identify targeted advertising related to a third user and present said targeted advertising on a display of a device being used by said third user.

4. The system of claim 3, wherein the analytics module is further configured to receive a search criteria from said first user, the search criteria comprising a geographic location, and in response to receiving the geographic location search criteria, present on a display of a device being used by said first user, a list of second users having the geographic location search criteria in the second user's set of completed travel locations or scheduled travel locations or desired travel locations.

5. A system comprising:
a non-transitory computer readable medium configured to store information and executable programmed modules;
a processor communicatively coupled with the non-transitory computer readable medium and configured to store information in and read information from non-transitory computer readable medium, the processor also configured to execute programmed modules stored in the non-transitory computer readable medium;
a social module stored in the non-transitory computer readable medium and configured to be executed by the processor, the social module configured to identify an existing connection between a first user and one or more second users, said existing connection maintained by a third party social service,
wherein the social module is further configured to:
analyze a plurality of comments associated with a content item being viewed by the first user;
identify an author of each of the plurality of comments;
determine if the author of a particular comment is one of said one or more second users; and
collapse or remove from being displayed each comment in the plurality of comments having an author who is not one of said one or more second users.

6. A system comprising:
a non-transitory computer readable medium configured to store information and executable programmed modules;
a processor communicatively coupled with the non-transitory computer readable medium and configured to store information in and read information from non-transitory computer readable medium, the processor also configured to execute programmed modules stored in the non-transitory computer readable medium;
a travel module stored in the non-transitory computer readable medium and configured to be executed by the processor, the travel module configured to receive instructions for maintaining a travel profile for a first user comprising a set of completed travel locations, a set of scheduled travel locations and a set of desired travel locations; and
an analytics module stored in the non-transitory computer readable medium and configured to be executed by the processor, the analytics module configured to:
analyze the set of completed travel locations, the set of scheduled travel locations and the set of desired travel locations of the first user;
analyze content of one or more digital media items provided to a device having a display being viewed by the first user;
compare the content of the one or more digital media items to the set of completed travel locations, the set of scheduled travel locations and the set of desired travel locations of the first user;
based on said comparison, identify one or more of the digital media items related to the set of completed travel locations, the set of scheduled travel locations and the set of desired travel locations of the first user; and
remove from being displayed each digital media item in the plurality of digital media items not related to the set of completed travel locations, the set of scheduled travel locations and the set of desired travel locations of the first user.

7. A system comprising:
a non-transitory computer readable medium configured to store information and executable programmed modules;
a processor communicatively coupled with the non-transitory computer readable medium and configured to store information in and read information from non-transitory computer readable medium, the processor also configured to execute programmed modules stored in the non-transitory computer readable medium;
a travel module stored in the non-transitory computer readable medium and configured to be executed by the processor, the travel module configured to receive instructions for maintaining a travel profile for a plurality of users comprising, for each user, a set of completed travel locations, a set of scheduled travel locations and a set of desired travel locations; and
an analytics module stored in the non-transitory computer readable medium and configured to be executed by the processor, the analytics module configured to:
analyze the set of completed travel locations, the set of scheduled travel locations and the set of desired travel locations of a plurality of users;
determine one or more common travel patterns, wherein a common travel patter comprises at least a visit to a first travel location followed by a visit to a second travel location and a mode of transportation between the first travel location and a the second travel location.

8. The system of claim 7, wherein the analytics module is further configured to:
identify a user in the process of planning future travel;
determine that the future travel plan of the first user includes the first travel location; and
present on a display being viewed by the first user a suggestion to include the second travel location in the future travel plan.

9. A computer implemented method where one or more processors are programmed to perform steps comprising:
receiving first input comprising a set of completed travel locations, a set of scheduled travel locations and a set of desired travel locations for a first user;
storing the first input in a memory;
translating the first input into map data having geographic boundaries;
generating a first data structure representing a map of the geographic boundaries of the set of completed travel locations, the set of scheduled travel locations and the set of desired travel locations for the first user;
generating a visual representation of the first data structure;
presenting the visual representation of the first data structure on a display being viewed by the first user;
obtaining a second data structure representing a map of geographic boundaries of a set of completed travel locations, a set of scheduled travel locations and a set of desired travel locations for a second user;
identifying one or more overlapping geographic boundaries between the first data structure and the second data structure;
generating a visual representation of the first data structure combined with the second data structure, wherein the geographic boundaries of the set of completed travel locations, the set of scheduled travel locations and the set of desired travel locations for the first user are visually distinct from the geographic boundaries of the set of completed travel locations, the set of scheduled travel locations and the set of desired travel locations for the second user and the one or more overlapping geographic boundaries between the first data structure and the second data structure are also visually distinct;
presenting the visual representation of the first data structure combined with the second data structure on the display being viewed by the first user.

10. A non-transitory computer readable medium having stored thereon one or more sequences of instructions for causing one or more processors to perform steps comprising:
receiving first input comprising a set of completed travel locations, a set of scheduled travel locations and a set of desired travel locations for a first user;
storing the first input in a memory;
translating the first input into map data having geographic boundaries;
generating a first data structure representing a map of the geographic boundaries of the set of completed travel locations, the set of scheduled travel locations and the set of desired travel locations for the first user;
generating a visual representation of the first data structure;
presenting the visual representation of the first data structure on a display being viewed by the first user;
obtaining a second data structure representing a map of geographic boundaries of a set of completed travel locations, a set of scheduled travel locations and a set of desired travel locations for a second user;
identifying one or more overlapping geographic boundaries between the first data structure and the second data structure;
generating a visual representation of the first data structure combined with the second data structure, wherein the geographic boundaries of the set of completed travel locations, the set of scheduled travel locations and the set of desired travel locations for the first user are visually distinct from the geographic boundaries of the set of completed travel locations, the set of scheduled travel locations and the set of desired travel locations for the second user and the one or more overlapping geographic boundaries between the first data structure and the second data structure are also visually distinct;
presenting the visual representation of the first data structure combined with the second data structure on the display being viewed by the first user.

11. The system of claim 2, further comprising an analytics module stored in the non-transitory computer readable medium and configured to be executed by the processor, the analytics module configured to analyze travel profiles for a plurality of users and identify targeted advertising related to a third user and present said targeted advertising on a display of a device being used by said third user.
